(19) United States
(12) Patent Application Publication
(10) Pub. No.: US 2008/0126898 A1
(43) Pub. Date: May 29, 2008

(54) SYSTEM AND METHOD FOR GENERATING ON-CHIP INDIVIDUAL CLOCK DOMAIN BASED SCAN ENABLE SIGNAL USED FOR LAUNCH OF LAST SHIFT TYPE OF AT-SPEED SCAN TESTING

(76) Inventor: Kamlesh Pandey, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/563,493

(22) Filed: Nov. 27, 2006

(51) Int. Cl. G06F 11/25

(52) U.S. Cl. 714/731; 714/726; 714/E11.155

(57) ABSTRACT

Presented herein are system(s) and method(s) for generating a individual clock domain based scan enable signal for launch of last shift type of at-speed scan testing. In one embodiment, there is presented a circuit for scan testing. The circuit comprises at least two flip flops, one OR gate, one inverter, and a multiplexer. The first flip flop comprises an input for receiving an external primary scan enable signal and second flip flop provides an output for providing a clock domain based scan enable signal in response to external primary scan enable signal. The multiplexer based on its control signal value either selects output of second flip flops or passes external primary scan enable signal at the output.

### RELATED APPLICATIONS

This application is related to “SYSTEM AND METHOD FOR GENERATING SELF-SYNCHRONIZED LAUNCH OF LAST SHIFT CAPTURE PULSES USING ON-CHIP PHASE LOCKED LOOP FOR AT-SPEED SCAN TESTING”, application Ser. No. ______, Attorney Docket No. 17684US01, filed ______, by Pandey. The foregoing application is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In very deep sub-micron designs, integrated circuit manufacturers are starting to see more defects that are not caught by traditional stuck-at-fault testing. Defects like high impendance metal, high impendance shorts, cross talk that may not be caught by traditional stuck at scan vectors show up as timing failures that are caught by at-speed testing.

Running a small number of functional vectors can be time consuming and may produce poor coverage. At speed testing can include transition delay testing and path delay testing. Both generate scan patterns that can be scanned in at a slow speed. After a scan vector is scanned in, two or more capture clock pulses can be applied at full speed and the captured result can be scanned out, usually at slow speed. This method uses sequential ATPG that reduces test coverage significantly in most designs.

Using a single primary scan enable signal to change the mode of scan flip-flip flops is complex because that scan enable has to switch at functional speed. This requirement forces very strict timing requirements on the scan enable signal. Scan enable signals are routed as a clock tree. Since the scan enable has to reach each scan flip-flip flop all over the chip, it is difficult to meet the timing requirements in large designs. Multiple clock frequencies can further complicate this.

For example in a design where one clock is running at 125 MHz and another clock is running at 200 MHz, there would be two different capture windows present. If the scan enable switches at 125 MHz, then the 200 MHz clock domain will be tested at a lower speed. If the scan enable switches at 200 MHz, the 125 MHz clock domain will be over tested.

Using separate scan enable signals per clock frequencies can allow multiple clock domains to be tested, but uses additional dedicated scan enable pins. A single signal cannot switch at a different rate in a given capture window.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for generating and distributing individual clock domain based scan enable for launch of last shift type of at-speed scan ATPG testing as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram of an exemplary circuit in accordance with an embodiment of the present invention;

FIG. 2 is a flow diagram for scan testing in accordance with an embodiment of the present invention;

FIG. 3 is a block diagram of another exemplary circuit in accordance with an embodiment of the present invention; and

FIG. 4 is a timing diagram for scan testing in accordance with an embodiment of the present invention.

### DETAILED DESCRIPTION OF THE INVENTION

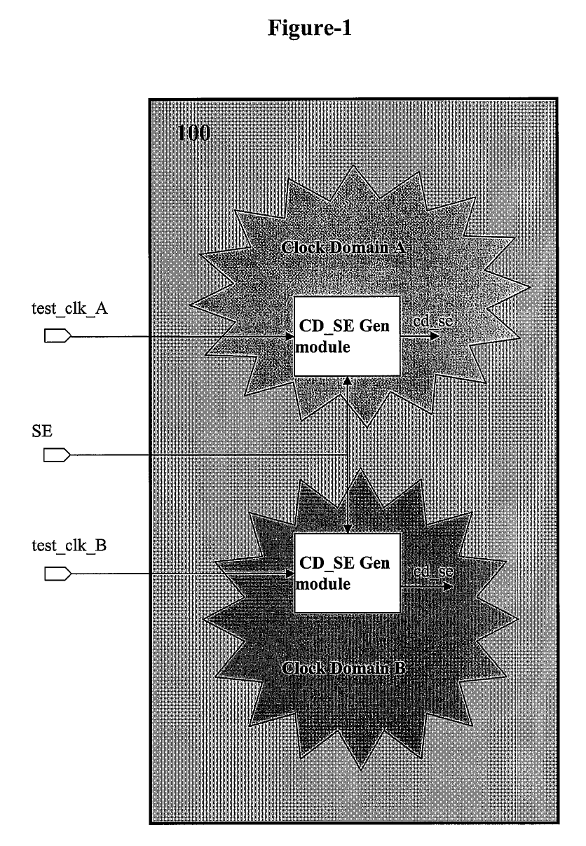

Referring now to FIG. 1, there is illustrated a block diagram of an exemplary circuit 100 in accordance with an embodiment of the present invention. The circuit 100 can include two clock domains namely test_clk_A and test_clk_B. The circuit also includes sea chip level scan enable signal se that is routed to each clock domain.

In the circuit 100, each clock domain comprises a clock domain scan enable generator (CD_SE_GEN) module. The scan enable SE, test clock test_clk A/B are input to the clock domain scan enable generator CD_SE_Gen and set. The output of CD_SE_GEN module is a clock domain based scan enable signal cd_se.

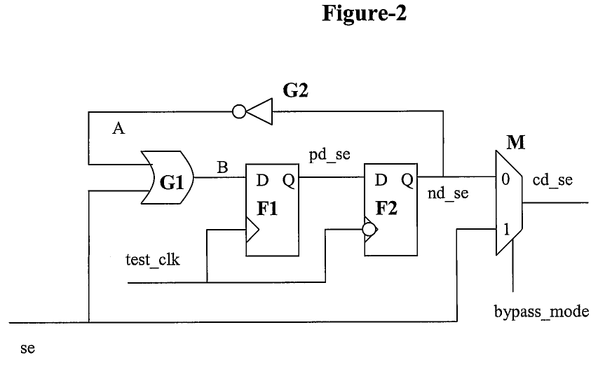

Referring now to FIG. 2, there is illustrated a block diagram of an exemplary clock domain scan enable generator module CD_SE_GEN. The clock dimain scan enable generator module CD_SE_GEN comprises flip flops F1, F2, a multiplexer M, an OR gate G1 and an inverter G2.

The flip flops F1 and F2 are clocked by test_clk that is supplied during scan atpg testing. The outputs of flip flops F1 and F2 can be preset (LOGIC HIGH) using an external preset signal. This preset signal is not shown in FIG. 2 in favor of clarity of the diagram. The F1 is positive edge triggered flip flop and F2 is negative edge triggered flip flop.

The OR gate G1 has two inputs, first one is se that comes from primary input pin and second one comes from output of flip flop F2 through an inverter G2. The output B of OR gate G1 is connected to D input of flip flop F1. The output of flip flop F1 pd_se is connected to D input of flip flop F2. The output of flip flop F2 nd_se is connected to 0 data input of multiplexer M. The 1 data input of the multiplexer M is connected from scan enable se input signal.

Based on logic value of control signal bypass_mode, the multiplexer M selects either nd_se or se as output cd_se. The output signal of multiplexer M cd_se is distributed to scan enable input of each flip flop that are clocked by clock signal test_clk.

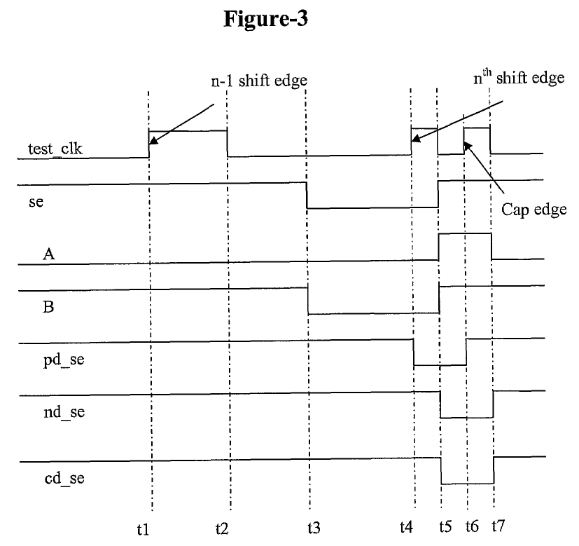

Referring now to FIG. 3, there is illustrated a timing diagram for scan testing in accordance with an embodiment of the present invention. The test setup process is applied at the beginning of the scan test. During test setup process the outputs of the flip flops F1 and F2 are preset to logic HIGH using preset signal. The scan enable signal se is asserted HIGH. The control signal bypass_mode is asserted to LOW in order to allow multiplexer M to select the output of flop flop F2 nd_se at the output cd_se. The control signal bypass_mode remains LOW for the duration of the test. The setup procedure needs to be applied only once in the scan test.

At the end of the setup procedure the output cd_se will be HIGH putting the circuit under test in scan shift mode. After setup process completes the normal scan chain loading starts.

Here, the scan chains are loaded in N shift cycles. At the end of N-1 shift cycle the primary scan enable se signal is asserted to LOW. In the timing diagram this happens at time t3. In response to the LOW logic value of se, output B of OR gate G1 goes LOW at time t3.

At time t4 the last (N^{th)} shift cycle begins. At time t4, on the rising edge of domain clock test_clk, the output pd_se of flip flop F1 goes LOW. At time t5 falling edge of the N^{th} cycle of test_clk captures LOW at the output nd_se of flip flop F2. The output cd_se of the multiplexer M goes LOW in response to the flop flop F2 output nd_se at time t5. The LOW leavel of multiplexer output cd_se puts all scan flip flops whose scan enables are connected to multiplexer output cd_se into scan capture mode.

In response to flip flop F2 output nd_se going LOW at time t5, the output A of inverter G2 goes HIGH. This results in output signal B of OR gate G1 going HIGH.

At time t6 the capture cycle starts. The rising edge of clock comain test_clk captures HIGH at the output pd_se of flip flop F1. At time t7 falling edge of clock domain test_clk arrives and captures HIGH at the output nd_se of flip flop F2. In response to output of flip flop F2 nd_se the output cd_se of multiplexer M goes HIGH indicating completion of capture cycle.

This completes one load and capture of one scan vector. Now scan enable se is asserted HIGH again for next load of scan vector. The load and capture process repeats for all the scan vectors.

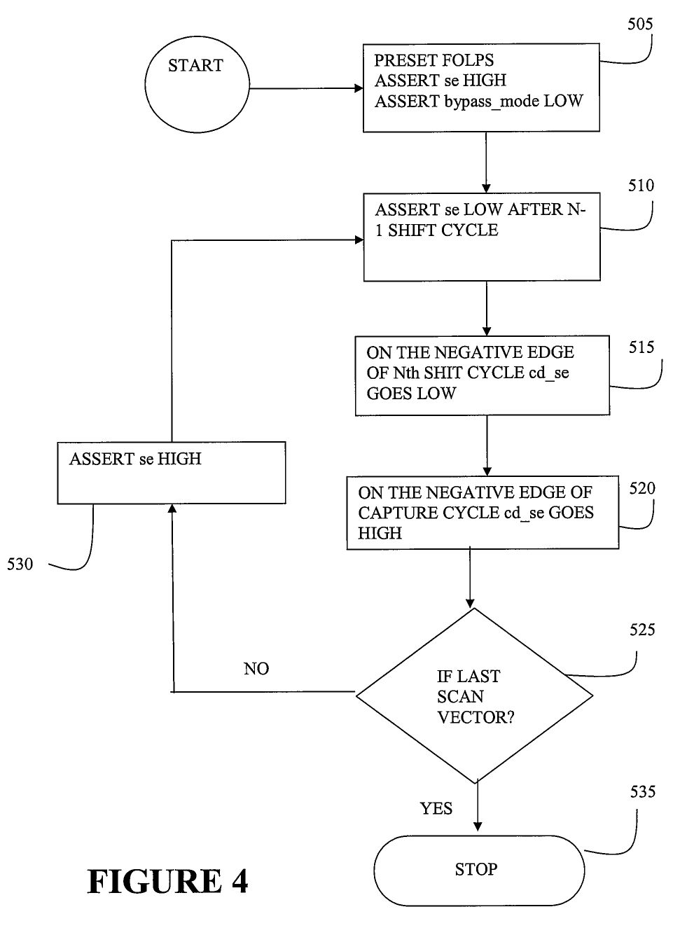

Referring now to FIG. 4, there is illustrated a flow diagram for scan testing in accordance with an embodiment of the present invention. Initially in step 505 the flip flops are in a preset state and the primary scan enable se is HIGH. Also control signal bypass_mode is set to LOW at the beginning of the test.

Next 510 starts after N-1 shift cycle completes. During 510, scan enable se is asserted LOW.

At 515 on the negative edge of Nth shift cycle clock domain based scan enable cd_se goes LOW.

At 520 on the negative edge of capture cycle cd_se goes HIGH again.

At 525 the condition is checked for end of scan test. If the scan vector is last then go to 535 indicating end of scan testing.

If the scan vector is not last then go to 530. At 530, scan enable se is asserted HIGH and step 510 to 525 are repeated.

Certain embodiments provide various advantages. For example, in certain embodiments of the present invention, each clock domain generates its own scan enable signal. In certain embodiments, the scan enable circuit can be duplicated many times within a single clock domain to ease routing problems. In certain embodiments, the generated scan enable is in synchronization with the parent clock domain. In certain embodiments of the present invention, the timing requirement on primary scan enable signal that goes to all over IC is eased to very comfortable level. In certain embodiments, clock domain based scan enable easily switches within one capture cycle, hence supporting launch of last shift type of at-speed scan testing.

The embodiments described herein may be implemented as a board level product, as a single chip, application specific integrated circuit (ASIC), or with varying levels of the system integrated with other portions of the system as separate components. Alternatively, if the processor is available as an ASIC core or logic block, then the commercially available processor can be implemented as part of an ASIC device wherein certain aspects of the present invention are implemented as firmware.

The degree of integration may primarily be determined by the speed and cost considerations. Because of the sophisticated nature of modern processors, it is possible to utilized a commercially available processor, which may be implemented external to an ASIC implementation.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for scan testing, said method comprising:
receiving an external scan enable signal, said external scan enable signal indicating a beginning of a capture cycle;
generating a local scan enable signal in response to receiving the external scan enable signal; and
switching scan flops from a shift mode to a capture mode after generating the local scan enable signal.

2. The method of claim 1, wherein the external scan enable signalis received at a first flip flop.

3. A circuit for scan testing, said circuit comprising:
at least one flip flop comprising:
an input for receiving an external scan enable signal; and
an output for providing a local scan enable signal in response to the input receiving the external scan enable signal; and
a multiplexer for providing the local scan enable signal to a clock domain.

4. The circuit of claim 3, wherein the external scan enable signal indicates the beginning of a capture cycle.

5. The circuit of claim 3, further comprising:
a clock for generating the local scan enable signal.

6. The circuit of claim 5, wherein the flip flop, multiplexer and clock are integrated on a single integrated circuit.

7. The circuit of claim 3, wherein the at least one flip flop provides the local scan enable signal to circuitry, wherein the circuitry provides the local scan enable signal to the multiplexer.

8. An integrated circuit comprising:
a functional circuit;
at least one flip flop comprising:
an input configured to receive an external synchronization signal; and
an output connected to the input, said output operably coupled to the function circuit to provide a local scan enable signal to the functional circuit in response to the input receiving the external synchronization signal; and
a multiplexer operably coupled to the at least one flip flop and the functional circuit to provide local scan enable to the at least one latch and the functional circuit.

9. The integrated circuit of claim 8, wherein the external scan enable signal indicates the beginning of a capture cycle.

10. The integrated circuit of claim 8, further comprising circuitry operably coupled to the multiplexer to provide the local scan enable signal to the multiplexer, and wherein the at least one flip flop is operably coupled to the circuitry to provide the local scan enable signal to the circuitry.
